(19) United States
(12) Patent Application Publication
(10) Pub. No.: US 2026/0310002 A1
(43) Pub. Date: Oct. 8, 2026

(54) OPTICAL WAVEGUIDE WITH APERTURE IRIS

(71) Applicant: LUMUS LTD., NESS ZIONA (IL)

(72) Inventors: Jonathan GELBERG, Ness Ziona (IL); Trion EISENFELD, Ness Ziona (IL); Netanel GOLDSTEIN, Ness Ziona (IL)

(73) Assignee: LUMUS LTD., NESS ZIONA (IL)

(21) Appl. No.: 19/108,338

(22) PCT Filed: May 30, 2024
(86) PCT No.: PCT/IB2024/055293

§ 371 Date: Mar. 3, 2025

Related U.S. Application Data
(60) Provisional application No. 63/469,577, filed on May 30, 2023.

(51) Int. Cl. G02B 27/09; G02B 27/01

(52) U.S. Cl. CPC G02B 27/0994; G02B 27/0172

(57) ABSTRACT

An optical waveguide is described herein that includes a pair of major surfaces and an aperture configured to receive an input beam. The waveguide also includes a first set of facets disposed along a first axis that are configured to reflect the input beam along a second axis. The waveguide further includes an iris matched to the aperture that is configured to block rays outside of the aperture from entering the optical waveguide. A first dimension of the aperture (and, thus, the iris) corresponds to a pitch of the first set of facets and a second dimension of the aperture (and, thus, the iris) corresponds to aspects of the waveguide corresponding to the second axis. By using the iris, overexposure of the waveguide and, thus, non-uniformity in a projected image, may be minimized.

### CROSS REFERENCE TO RELATED APPLICATION

This application claims the benefit of U.S. Provisional Application No. 63/469,577, filed on May 30, 2023. The entire disclosure of U.S. Provisional Application No. 63/469,577 is incorporated by this reference.

### BACKGROUND

Unless otherwise indicated herein, the materials described in this section are not prior art to the claims in this application and are not admitted to be prior art by inclusion in this section.

The present disclosure relates in general to systems and methods of presenting information to a user, more particularly, to optical systems and near eye displays for presenting information to a user.

In some optical waveguides, homogenizers (also known as mixers) are disposed between major surfaces of the waveguides. Such homogenizers may mix weaker and stronger rays within the waveguides which can result in improved uniformity of light. Furthermore, the homogenizers may allow for smaller entrance pupils and, thus, smaller projectors. While the homogenizers may provide the benefits above, they can also introduce non-uniformities if light enters the waveguides beyond the smaller apertures enabled by the mixers.

### SUMMARY

An optical waveguide with an aperture iris is described herein. The optical waveguide includes a pair of major surfaces that are parallel and an aperture configured to receive an input beam. The aperture has a first dimension. The optical waveguide also includes a coupling-in element configured to receive the input beam from the aperture and couple the input beam into the optical waveguide. The optical waveguide further includes a first set of facets that are disposed between the major surfaces along a first axis and configured to receive the input beam from the coupling-in element and at least partially reflect the input beam. The optical waveguide also includes an iris that is configured to block rays outside of the aperture from entering the optical waveguide. The first dimension corresponds to the pitch of the first set of facets.

An apparatus is also described herein. The apparatus includes a projector configured to produce an input beam. The apparatus also includes the optical waveguide discussed above. It should be noted that the iris of the apparatus may also be on an exit of the display system (e.g., on an external surface of a projector) instead of on, or as a part of, (e.g., on an entrance to) the optical waveguide.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates an example of a system including an optical waveguide with an aperture iris, in accordance with various examples of the present disclosure.

FIG. 2 illustrates an example of an optical waveguide including an aperture iris, in accordance with various examples of the present disclosure.

FIG. 3 illustrates another view of the optical waveguide of FIG. 2, in accordance with various examples of the present disclosure.

FIG. 4A illustrates another view of the optical waveguide of FIG. 2 with a single homogenizer, in accordance with various examples of the present disclosure.

FIG. 4B illustrates another view of the optical waveguide of FIG. 2 with two homogenizers, in accordance with various examples of the present disclosure.

FIG. 5A illustrates over illumination caused by light entering outside of a first dimension of an aperture of an optical waveguide, in accordance with various examples of the present disclosure.

FIG. 5B illustrates over illumination caused by light entering outside of a second dimension of an aperture of an optical waveguide, in accordance with various examples of the present disclosure.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

To be described in more detail below, a wearable device, such as a near eye display and/or smart glasses, can be implemented by a system and method described in accordance with the present disclosure. The system can efficiently provide high quality optical information to a user in various applications.

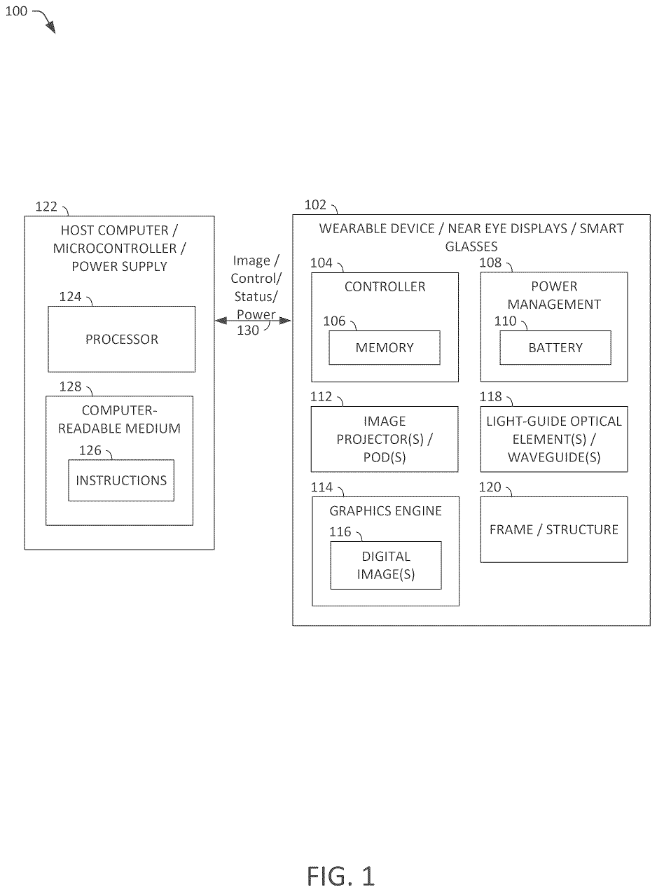

FIG. 1 illustrates a block diagram of an example of an optical system 100 containing an optical waveguide with an aperture iris. Optical system 100 may include two or more devices or components. Optical system 100 may be implemented generally as a hybrid system including various electronic, optical, and electro-optical elements. To be described in more detail below, optical system 100 may include a wearable device 102, such as one or more near eye displays or smart glasses, which may be worn on or about the head of a user to convey optical information to one or more eyes of a user.

Wearable device 102 may include a controller 104 with a memory 106 where controller 104 may be configured to send and receive electrical signals to various other elements in optical system 100, to execute program instructions stored in memory 106 in order to process and provide information, to operate wearable device 102, and to interact with other systems outside wearable device 102, for example. Controller 104 may include a microcontroller, a processor, various discrete components, programmable logic devices, and/or various interface circuits that may access memory 106 which may be removable, replaceable, programmable, and reprogrammable to update instructions to controller 104.

Wearable device 102 may also include a power management module 108 having a battery 110, where power management module 108 may be configured to charge, discharge, and monitor power usage for battery 110. Various elements of wearable device 102 may receive power from battery 110, including controller 104, one or more image projector(s) 112 (e.g., a projecting optical device, or POD), and a graphics engine 114 having one or more digital images 116, for example.

Each of the image projector(s) may be configured to produce a collimated image beam based on the digital image(s) 116. The collimated image beam may be an illuminated representation of the digital image having an image field which is a two-dimensional representation of the digital image based on either a single graphical image (e.g., a static image) or a sequence of graphical images (e.g., a moving image). The collimated image beam may be collimated to infinity.

Wearable device 102 may also include one or more light-guide optical elements 118 (e.g., LOEs, also denoted as waveguides WGs, waveguide with aperture iris) comprising transparent materials configured to receive and propagate light, where light may enter into and exit from various external and internal surfaces of light-guide optical elements 118. For example, the transparent materials comprising light-guide optical elements 118 may include optical glass or other suitable material that is transformed into complex optical structures using a process that may include coating, stacking, slicing, polishing, and shaping the transparent materials. The process may include the addition of partially reflective or fully reflective materials such as mirror coatings, for example. Similarly, the process may also include the addition of partially opaque or fully opaque materials such as light covers to block light, for example.

Graphics engine 114 may be coupled to image projector(s) 112 and light-guide optical element(s) 118. Graphics engine 114 may be configured to directly operate image projector(s) 112 under the direction of the controller 104. For example, graphics engine 114 may provide graphics processing for the digital image before projection of an illuminated representation of the digital image by image projector(s) 112.

Wearable device 102 may also include a frame 120 (e.g., a structure) for supporting and retaining one or more elements in wearable device 102. For example, frame 120 may support and retain a first image projector 112a in position next to a first light-guide optical element 118a.

Similarly, frame 120 may support and retain a second image projector 112b in position next to a second light-guide optical element 118b. In this manner, frame 120 may support and retain one or two image projector(s) 112 and one or two light-guide optical element 118 on or about the head of a user. References are made herein regarding the orientation of various elements relative to each other. Such references may also include reference to various elements of wearable device 102 when supported by frame 120 or in reference to a coordinate system (e.g., X, Y, Z axes).

Optical system 100 may also include a host computer 122 that may include a processor 124 configured to read and execute operations based on instructions 126 stored in a computer-readable medium 128. Instructions 126 may include at least some instructions provided to controller 104 and stored in memory 106. Host computer 122 may communicate with one or more elements of wearable device 102 over a signal and power bus 130. In this manner, host computer 122 may provide power to charge battery 110, provide instructions to and receive status from controller 104 and various other elements of wearable device 102, and to provide digital image data to graphics engine 114.

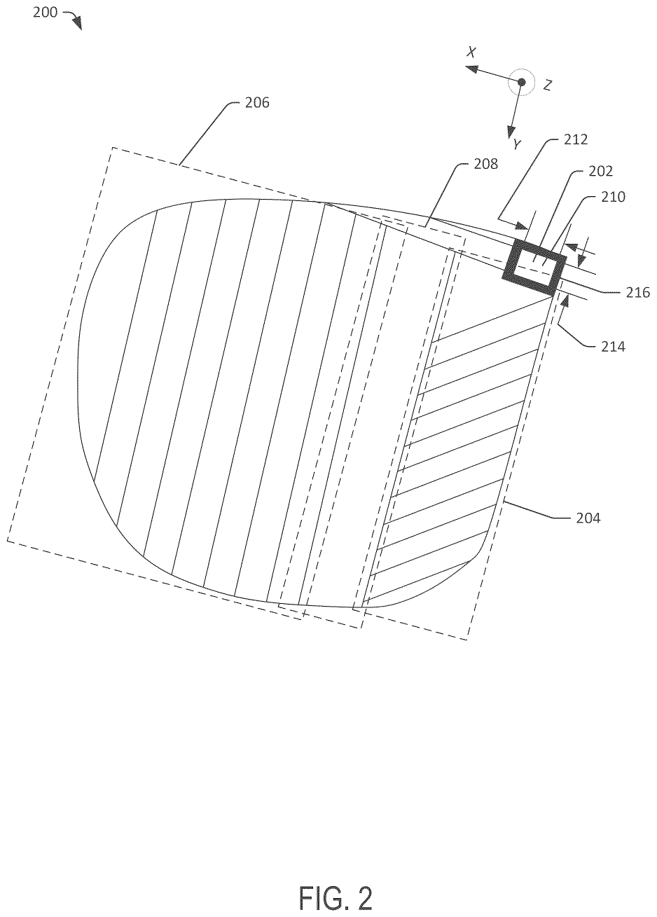

FIG. 2 illustrates an example of an optical waveguide (hereinafter waveguide 200) with an aperture iris. Waveguide 200 may be one of light-guide optical element(s) 118. A three-dimensional cartesian coordinate system (e.g., X, Y, and Z axes) is illustrated. The same coordinate system is used throughout for clarity. The coordinate system used may vary (e.g., axes and directions) without departing from the scope of this disclosure.

An input beam from one of image projector(s) 112 (not shown) enters waveguide 200 through an aperture 202. In the illustrated example, aperture 202 is disposed on a major surface (e.g., one of two major surfaces) of waveguide 200. In some implementations, aperture 202 may be disposed on other surfaces or objects (e.g., a coupling-in prism).

Surrounding aperture 202 is an iris 216. Iris 216 may be configured to block rays outside of aperture 202 from entering waveguide 200.

The input beam propagates via total internal reflection (TIR) between the major surfaces of the waveguide 200 towards a first set of facets 204. First set of facets 204 may be perpendicular or oblique to external surfaces of the waveguide 200 and is configured to at least partially reflect the input beam towards a second set of facets 206. The beams reflected by first set of facets 204 propagate via TIR between the major surfaces between first set of facets 204 and second set of facets 206. Second set of facets 206 may be oblique to the external surfaces of the waveguide 200 and is configured to at least partially reflect the beams from first set of facets 204 out of waveguide 200 (e.g., towards an eye box). In order to generate a uniform image, a cross-section of waveguide 200 may be fully illuminated.

Between first set of facets 204 and second set of facets 206 may be one or more homogenizer(s) 208. In some implementations, homogenizer(s) 208 may be disposed in a same area as first set of facets 204 or second set of facets 206 (e.g., instead of between them).

Homogenizer(s) 208 may be any type of light homogenizer configured to provide improved illumination uniformity. For example, homogenizer(s) 208 may comprise a partial plane reflector as a semi-reflective surface, a partially transmissive surface, or film (e.g., partially reflective dielectric coating) added within waveguide 200. Homogenizer(s) 208 may effectively fill gaps in illumination within the waveguide 200 by splitting beams traversing waveguide 200.

The input beam generally propagates parallel to the Y axis from a coupling-in element 210 (e.g., mirror or prism) towards first set of facets 204 (they may reflect via TIR in the Y-Z plane but generally progress in a direction parallel to the Y axis). When it is reflected by first set of facets 204, the reflected input beams generally propagate parallel to the X axis (they may reflect via TIR in the X-Z plane but generally progress in a direction parallel to the X axis). When they are reflected by second set of facets 206, the beams generally propagate parallel to the Z direction (e.g., out of the waveguide 200). The propagation directions may differ angularly from the axes without departing from the scope of this disclosure.

As used herein, each set or group of facets may include a plurality of planar, mutually parallel and partially reflecting optical elements (e.g., facets) spaced apart from each other. Hence, each of the facets of a respective group may be parallel to each other and disposed at the same perpendicular or oblique angle. Also, the facets described herein may include an angularly selective coating and may be controlled to have multiple states (e.g., on/off) or to change a level of reflectivity and/or transmissivity of each facet or a cooperative collection of facets in a structure.

Returning to aperture 202, aperture 202 is generally rectangular and has a first dimension 212 and a second dimension 214. Aperture 202 may be surrounded by iris 216. Furthermore, iris 204 has an internal opening that may match aperture 202. In other words, iris 216 may have first and second interior dimensions that are aligned/match first dimension 212 and second dimension 214. In some implementations, dimensions of the internal opening of iris 216 may be slightly smaller than first dimension 212 and second dimension 214. The external dimensions of iris 216 may vary without departing from the scope of this disclosure.

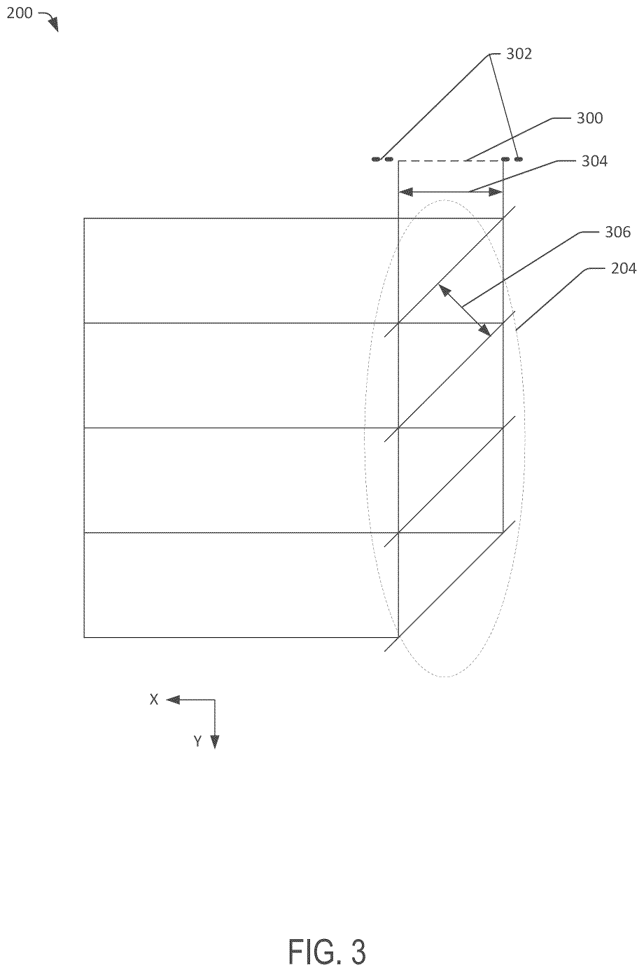

FIG. 3 illustrates an example of the waveguide 200 from a different view than FIG. 2. The illustrated example is from a similar direction (e.g., from a direction normal to the X-Y plane) but rotated for clarity.

In the illustrated example, a projected aperture 300 and a projected iris 302 are shown. Projected aperture 300 and projected iris 302 are not physically in the location shown but projected from aperture 202 and iris 216 to illustrate the effect of the sizing of aperture 202 and iris 216. A first length 304 of projected aperture 202 in the X direction corresponds to first dimension 212 of aperture 202.

First length 304 and, thus, first dimension 212, corresponds to a pitch of first set of facets 204. For example, first dimension 212 may be linearly related to the pitch of first set of facets 204. The pitch of first set of facets 204 may be a distance 306 between each adjacent pair of facets in a direction normal to the facets (e.g., a closest distance between them). The pitch (e.g., distance 306) may be constant between facets of first set of facets 204 or may vary amongst first set of facets 204. In either case, first dimension 212 is linearly related to each of one or more pitches within first set of facets 204.

Projected iris 302 covers an area outside of first length 304 of the projected aperture 300. Similarly, the iris 216 blocks rays outside of the first dimension 212 (which is related to the length 304) of the aperture 202 from entering the waveguide 200.

Homogenizer(s) 208 and second set of facets 206 may be to the left of FIG. 3. As discussed above, first set of facets 204 may at least partially reflect an input beam received from a coupling-in element towards the second set of facets 206 via homogenizer(s) 208.

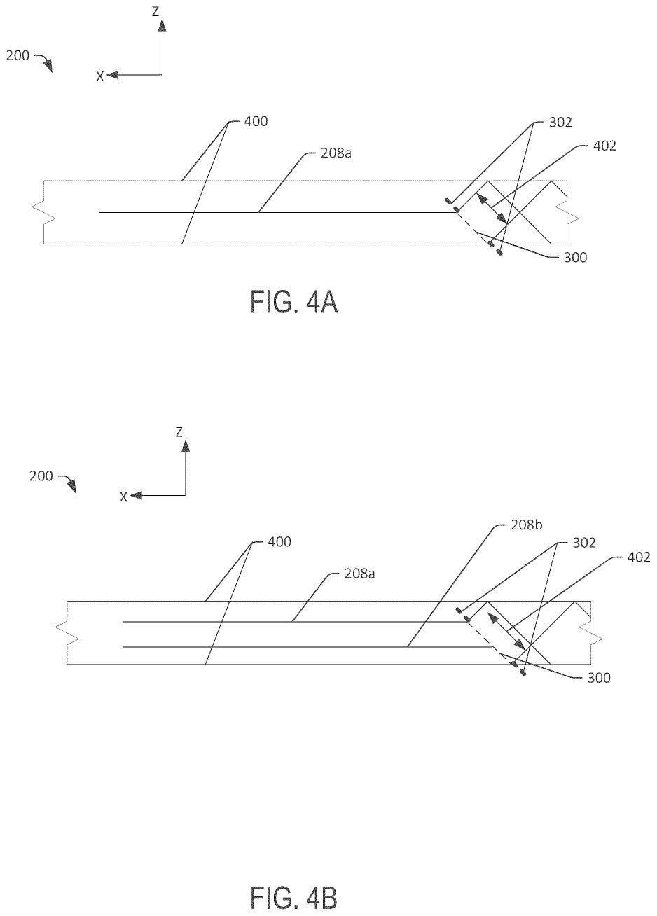

FIGS. 4A and 4B illustrate examples of waveguide 200 with one or two homogenizers, respectively, from a different view than FIG. 2. For example, FIGS. 4A and 4B are viewed along an axis normal to the X-Z plane.

The example of FIG. 4A or FIG. 4B may be used separately or in conjunction with the illustrated example of FIG. 3. Waveguide 200 of FIG. 4A includes a first homogenizer 208a disposed between two major surfaces 400. In the illustrated example, the first homogenizer 208a is equidistant between the two major surfaces 400. Waveguide 200 of FIG. 4B includes the first homogenizer 208a and a second homogenizer 208b. In the illustrated example, first homogenizer 208a and second homogenizer 208b trisect a space between two major surfaces 400. The configurations of the homogenizer(s) 208 between major surfaces 402 may vary without departing from the scope of this disclosure. In both illustrated examples, second set of facets 206 may be to a left of the homogenizer(s) 208.

To mitigate possible overexposure of the waveguide 200 along the illustrated axis (e.g., along the X direction), second dimension 214 of aperture 202 is surrounded by iris 216. Projected aperture 300 and projected iris 302 are also illustrated (albeit in a different dimension to FIG. 3). Projected iris 302 is shown to illustrate areas to be blocked by iris 216. Second dimension 214 corresponds to a second length 402 of projected aperture 300.

It should be noted that iris 216 may not be necessary for the illustrated example of FIG. 4B. The wider aperture in that dimension may enable better matching of the projector to aperture 202, which may obviate a need for iris 216.

Thus, first dimension 212 is correlated with the pitch of first set of facets 204, and second dimension 214 is correlated with aspects of waveguide 200 in a direction of second set of facets 206 (e.g., in the X direction). The aspects may include one or more of a thickness of waveguide 200, location of the homogenizer(s) 208, the field of view in the X direction, an angle of second set of facets 206, or an angle of the coupling-in element 210. By using iris 216 to block rays outside of first dimension 212 and second dimension 214, overexposure may be mitigated.

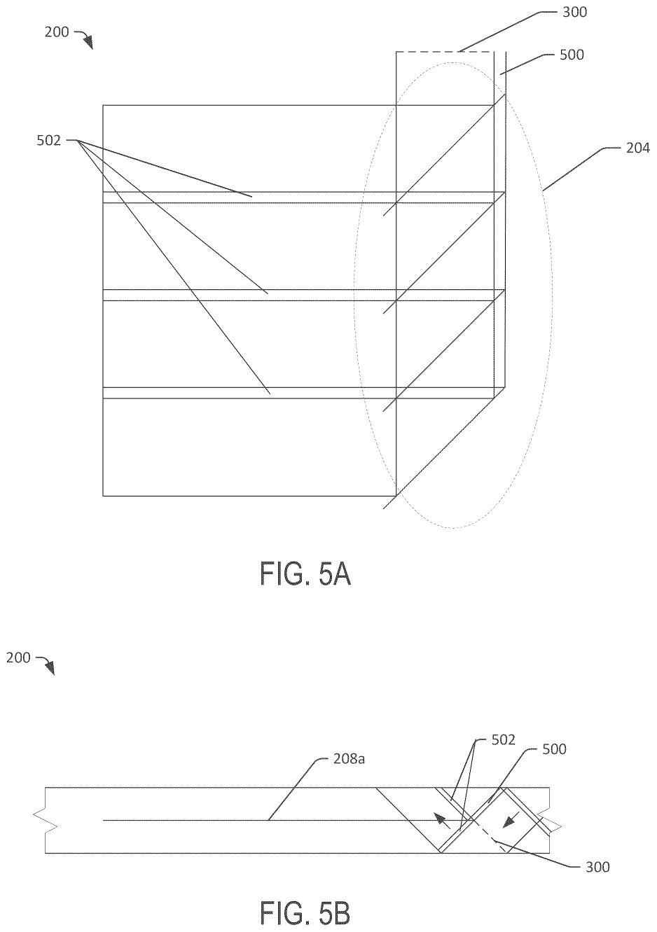

FIGS. 5A and 5B illustrate examples of overexposure when iris 216 is not implemented. The example of FIG. 5A illustrates overexposure due to rays entering outside of first dimension 212. The example of FIG. 5B illustrates overexposure due to rays entering outside of second dimension 214. In either case, errant rays 500 (e.g., rays outside of the respective dimensions) enter waveguide 200 and create overexposure zones 502. Overexposure zones 502 correspond to areas where the desired beams (e.g., those within first dimension 212 and second dimension 214) overlap with reflections of the errant rays 500.

In the example of FIG. 5A, errant rays 500 are at least partially reflected by first set of facets 204 to create overexposure zones 502. In the example of FIG. 5B, errant rays 500 interact with homogenizer(s) 208 to create overexposure zones 502 (e.g., by superimposing on the desired beams). In either case, overexposure zones 502 are propagated through and out of waveguide 200.

The iris 216 may block the errant rays 500 from entering the waveguide 200. By doing so, the overexposure zones 502 may be mitigated. Accordingly, a more uniform illumination may be achieved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms up, upper, down, lower, above, below, left, right, forward, rearward, and the like are intended to be understood in the context of the representations described and illustrated above so that a wearable device may have such an orientation in reference to the frame or to various elements as supported by the frame or as illustrated in the drawing figures.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The various embodiments were chosen and described in order to best explain the principles of the invention and the practical application, and to enable others of ordinary skill in the art to understand the invention for various embodiments with various modifications as are suited to the particular use contemplated.

### EXAMPLES

Example 1: An optical waveguide comprising: a pair of major surfaces that are parallel; an aperture configured to receive an input beam, the aperture having a first dimension; a coupling-in element configured to receive the input beam from the aperture and couple the input beam into the optical waveguide; a first set of facets disposed between the major surfaces along a first axis and configured to receive the input beam from the coupling-in element and at least partially reflect the input beam; and an iris matched to the aperture and configured to block rays outside of the aperture from entering the optical waveguide, wherein the first dimension of the aperture corresponds to a pitch of the first set of facets.

Example 2: The optical waveguide of example 1, wherein the aperture has a second dimension that corresponds to aspects of the optical waveguide corresponding to a second axis.

Example 3: The optical waveguide of example 2, wherein: the optical waveguide further comprises a second set of facets disposed between the major surfaces along the second axis; the first set of facets is configured to at least partially reflect the input beam towards the second set of facets; and the second set of facets is configured to at least partially reflect beams from the first set of facets out of the optical waveguide.

Example 4: The optical waveguide of example 3, wherein the optical waveguide further comprises a first homogenizer disposed between, and parallel to, the major surfaces.

Example 5: The optical waveguide of example 4, wherein the second dimension of the aperture corresponds to a distance between the first homogenizer and one of the major surfaces.

Example 6: The optical waveguide of example 4 or 5, wherein the first homogenizer is disposed within an area between the first set of facets and the second set of facets.

Example 7: The optical waveguide of example 4 or 5, wherein the first homogenizer is disposed within a same area as the first set of facets or the second set of facets.

Example 8: The optical waveguide of any of examples 4 to 7, wherein the first homogenizer is equidistant from each of the major surfaces.

Example 9: The optical waveguide of any of examples 4 to 8, wherein the optical waveguide further comprises a second homogenizer disposed between the first homogenizer and one of the major surfaces.

Example 10: The optical waveguide of any of examples 2 to 9, wherein the second dimension of the aperture is smaller than the first dimension of the aperture.

Example 11: The optical waveguide of any preceding example, wherein the pitch of the first set of facets corresponds to a distance between adjacent facets of the first set of facets along the first axis.

Example 12: The optical waveguide of any preceding example, wherein the aperture and iris are disposed on one of the major surfaces.

Example 13: The optical waveguide of any preceding example, wherein the iris comprises an opening that is aligned with the aperture.

Example 14: The optical waveguide of any preceding example, wherein the coupling-in element comprises a mirror or a prism.

Example 15: An apparatus comprising: a projector configured to produce an input beam; and the optical waveguide of any preceding example.

Example 16: An apparatus comprising: an optical waveguide comprising: a pair of major surfaces that are parallel; an aperture configured to receive an input beam, the aperture having a first dimension; a coupling-in element configured to receive the input beam from the aperture and couple the input beam into the optical waveguide; and a first set of facets disposed between the major surfaces along a first axis and configured to receive the input beam from the coupling-in element and at least partially reflect the input beam, wherein the first dimension corresponds to a pitch of the first set of facets; and a projector configured to produce an input beam, the projector including an iris matched to the aperture of the optical waveguide and configured to block rays outside of the aperture of the optical waveguide from entering the optical waveguide.

1. An optical waveguide comprising:
a pair of major surfaces that are parallel;
an aperture configured to receive an input beam, the aperture having a first dimension;
a coupling-in element configured to receive the input beam from the aperture and couple the input beam into the optical waveguide;
a first set of facets disposed between the major surfaces along a first axis and configured to receive the input beam from the coupling-in element and at least partially reflect the input beam; and
an iris matched to the aperture and configured to block rays outside of the aperture from entering the optical waveguide, wherein the first dimension of the aperture corresponds to a pitch of the first set of facets.

2. The optical waveguide of claim 1, wherein the aperture has a second dimension that corresponds to aspects of the optical waveguide corresponding to a second axis.

3. The optical waveguide of claim 2, wherein: the optical waveguide further comprises a second set of facets disposed between the major surfaces along the second axis; the first set of facets is configured to at least partially reflect the input beam towards the second set of facets; and the second set of facets is configured to at least partially reflect beams from the first set of facets out of the optical waveguide.

4. The optical waveguide of claim 3, wherein the optical waveguide further comprises a first homogenizer disposed between, and parallel to, the major surfaces.

5. The optical waveguide of claim 4, wherein the second dimension of the aperture corresponds to a distance between the first homogenizer and one of the major surfaces.

6. The optical waveguide of claim 4, wherein the first homogenizer is disposed within an area between the first set of facets and the second set of facets.

7. The optical waveguide of claim 4, wherein the first homogenizer is disposed within a same area as the first set of facets or the second set of facets.

8. The optical waveguide of claim 4, wherein the first homogenizer is equidistant from each of the major surfaces.

9. The optical waveguide of claim 4, wherein the optical waveguide further comprises a second homogenizer disposed between the first homogenizer and one of the major surfaces.

10. The optical waveguide of claim 2, wherein the second dimension of the aperture is smaller than the first dimension of the aperture.

11. The optical waveguide of claim 1, any preceding claim, wherein the pitch of the first set of facets corresponds to a distance between adjacent facets of the first set of facets along the first axis.

12. The optical waveguide of claim 1, wherein the aperture and iris are disposed on one of the major surfaces.

13. The optical waveguide of claim 1, wherein the iris comprises an opening that is aligned with the aperture.

14. The optical waveguide of claim 1, wherein the coupling-in element comprises a mirror or a prism.

15. An apparatus comprising:
a projector configured to produce an input beam; and
the optical waveguide of claim 1.

16. The optical waveguide of claim 5 wherein the first homogenizer is disposed within an area between the first set of facets and the second set of facets.

17. The optical waveguide of claim 5, wherein the first homogenizer is disposed within a same area as the first set of facets or the second set of facets.

18. The optical waveguide of claim 5, wherein the first homogenizer is equidistant from each of the major surfaces.

19. The optical waveguide of claim 5, wherein the optical waveguide further comprises a second homogenizer disposed between the first homogenizer and one of the major surfaces.

20. The optical waveguide of claim 3, wherein the second dimension of the aperture is smaller than the first dimension of the aperture.
